(19) United States
(12) Patent Application Publication
(10) Pub. No.: US 2026/0057193 A1
(43) Pub. Date: Feb. 26, 2026

(54) TECHNIQUES FOR TRANSLATING A RECEIVED MESSAGE INTO A PREFERRED LANGUAGE OF A PORTABLE ELECTRONIC DEVICE

(71) Applicant: Relay, Inc., Raleigh, NC (US)

(72) Inventors: Sai Rathnam, Raleigh, NC (US); Adam Cook, Apex, NC (US); Scott Hiller, Raleigh, NC (US); Jared Kashimba, Micanopy, FL (US)

(73) Assignee: Relay, Inc., Raleigh, NC (US)

(21) Appl. No.: 18/815,053

(22) Filed: Aug. 26, 2024

(51) Int. Cl. G06F 40/58

(52) U.S. Cl. CPC G06F 40/58

(57) ABSTRACT

Techniques are disclosed for translating a message intended for a recipient portable communication device (PCD) into a preferred language. In a communications platform server (CPS), a message is received from a sending PCD intended for a recipient PCD, the message being one of a voice message or a text message. The CPS determines a language for the message received from the sending PCD as well as determining two or more language settings associated with the recipient PCD. When the language of the received message matches at least one of the language settings associated with the recipient PCD, the CPS sends the received message to the recipient PCD without performing a message translation process. When the language of the message does not match any of the language settings associated with the recipient PCD, the CPS performs a message translation process to translate the received message into the preferred language setting associated with the recipient PCD and sends the translated received message to the recipient PCD.

### CROSS-REFERENCE TO RELATED APPLICATIONS

This application is a continuation-in-part of U.S. patent application Ser. No. 18/658,364 filed on May 8, 2024 entitled, “Techniques for Translating Messages Into Multiple Languages Among a Group of Portable Electronic Devices” which claims priority to and the benefit of U.S. Provisional Patent Application 63/634,615 filed on Apr. 16, 2024 entitled, “Techniques for Translating Messages Into Multiple Languages Among a Group of Portable Electronic Devices.”

### TECHNICAL FIELD

Examples described herein are generally related to techniques for translating voice and/or text messages among two or more languages exchanged among two or more associated portable electronics devices.

### BACKGROUND

Group communications over portable electronic devices like walkie-talkies or other purpose built wireless communication devices are valuable to enterprises. For instance, many security teams utilize communication devices to communicate with one another. Similarly, other teams of workers may have a need for group communications. Often, a team of workers grouped together may not all speak the same language, making group communications difficult when multiple languages may be needed for efficient communication.

What is needed is a technique for determining the preferred language for each user/device that is party to a group communication channel and converting, when necessary, an incoming voice or text message to the preferred language for that user/device.

### SUMMARY

Various embodiments of the present disclosure relate to techniques for translating audio messages from one language into various other specified languages for portable communication devices that comprise a group of users having different language preferences.

In one embodiment, a method of translating a message intended for a recipient portable communication device (PCD) into a preferred language is disclosed. In a communications platform server (CPS), a message is received from a sending PCD intended for a recipient PCD. The message may be one of a voice message or a text message. The CPS may determine a language of the message received from the sending PCD. The CPS may then determine two or more language settings associated with the recipient PCD. When the language of the sent message matches at least one of the language settings associated with the recipient PCD, the CPS may send the sent message to the recipient PCD without performing a message translation process. But, when the language of the message does not match any of the language settings associated with the recipient PCD, the CPS may perform a message translation process to translate the sent message into a language setting associated with the recipient PCD. The CPS may then send the translated sent message to the recipient PCD.

In some embodiments, the sending PCD and recipient PCD may be associated with a configurable user profile. The user profile may include the language settings of the PCDs. For PCDs with multiple language settings, one of the language settings may be indicative of a preferred language setting.

In some embodiments, the CPS maintains a record of the user profiles associated with the sending PCD and recipient PCD.

In some embodiments, the configurable user profile may include a format setting for message playback. The format setting may be used to determine how messages received by a recipient PCD will be played or displayed.

In some embodiments, the format setting may include voice and text.

In some embodiments, when a translation process is not necessary, the CPS may determine the format setting for the recipient PCD. When the format setting is set to text and the sent message from the sending PCD is a voice message, the CPS may perform a speech-to-text (STT) conversion of the sent message. When the format setting is set to voice and the sent message from the sending PCD is a text message, the CPS may perform a text-to-speech (TTS) conversion of the sent message. The sent message may then be sent to the recipient PCD as a text message when the format setting is set to text and as a voice message when the format setting is set to voice.

In some embodiments, when a translation process is necessary, the CPS may convert the sent message from the sending PCD to a text message using a speech-to-text (STT) process if the sent message from the sending PCD is a voice message. The CPS may then perform the translation process on the text message to translate it into the preferred language setting of the recipient PCD. When the format setting is set to text, the translated text message is sent to the recipient PCD. When the format setting is set to voice, the translated text message is converted to speech using a text-to-speech (TTS) process and sent to the recipient PCD.

The aforementioned methods may also be implemented as computer systems that are configured to execute the methods. Additionally, the methods may be implemented by non-transitory computer-readable mediums comprising program instructions executable by a processor that cause the processor to execute the methods.

Any illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the examples, serve to explain the principles and implementations of the one or more certain examples.

FIG. 1 illustrates a network environment for a wireless communication system according to the embodiments of the invention.

FIG. 2 illustrates some of the data residing on a personal communication device (PCD) according to embodiments of the invention.

FIG. 3 is a logic flow diagram describing a language translation process according to embodiments of the invention.

FIG. 4 is another logic flow diagram describing a language translation process according to embodiments of the invention.

FIG. 5 is another logic flow diagram describing a language translation process according to embodiments of the invention.

### DETAILED DESCRIPTION

Although the above operations are described sequentially, many of the operations can be performed in parallel or concurrently. In addition, the order of the operations may be rearranged. A process may have additional steps not included in FIG. 2. Furthermore, examples of the methods may be implemented by hardware, software, firmware, middleware, microcode, hardware description languages, or any combination thereof. When implemented in software, firmware, middleware, or microcode, the program code or code message segments to perform the necessary tasks may be stored in a non-transitory computer-readable medium such as a storage medium. Processors may perform the described tasks.

The embodiments described herein utilize a communication system comprising a plurality of portable communication devices (PCDs) that are managed by a cloud based communication platform server (CPS). Each individual portable communication device establishes a connection with the CPS. The CPS may then manage communication among the PCDs. It should be noted that a PCD may comprise a purpose built device like those made by Relay, Inc., a smartphone executing an application that is configured to communicate with the CPS, or a laptop or other computer executing an application that is configured to communicate with the CPS.

In operation, the various PCDs may coordinate with the CPS to create logical communication channels. A logical communication channel may be characterized as a specific grouping of PCDs. Each PCD may be a member of multiple logical channels. The CPS maintains a list of logical channels and the PCDs that are members of the logical channel. A PCD may then switch itself to a logical channel for purposes of communicating with other PCDs on that logical channel. The CPS, in some situations, can manipulate the logical channels on a given PCD causing it to switch to another logical channel if necessary.

Each PCD is enabled with a user profile. The user profile is associated with a person and is unique to that person. Any given PCD may be configured with a user profile and user profiles may be deleted or added to PCDs via an administration function. A PCD may only be configured with a single user profile at any given time.

There are a variety of settings that may be associated with a user profile. These settings may then influence or control what the PCD can access on the network. For instance, a user profile may contain the role or job function (e.g., security, housekeeping, front desk, etc.) of the user which in turn may affect which logical channels that PCD may be a party to. Similarly, the job function may define a geo-fenced boundary of where that PCD may be permitted.

Of more relevance to the present disclosure, the user profile may include language settings. For example, the user may specify one or more languages in which the user may be fluent or conversant. If there is more than one language associated with the profile, one may be deemed the default language. Moreover, the user may specify one language for outbound communications and another language for inbound communications.

Consider a logical channel comprised of four (4) users. The logical channel may have been created and given a label such as, for instance, HQ Security. Each user is associated with a PCD and each PCD is provisioned with that user's user profile. In this example, we will refer to the users as Bob, Maria, Pierre, and Alice. Bob speaks only English, Maria speaks Spanish, Pierre speaks both French and English, and Alice speaks Chinese. While Pierre speaks both French and English, he prefers to speak in French but listen in English.

Any user may initiate a conversation on the HQ Security channel by speaking a message into the PCD while it is set to the HQ Security channel and is in transmit mode. It is assumed that all the PCDs are also set to the HQ Security channel for purposes of this illustration. In general, a user will speak a message in their default language which is relayed up to the CPS. The CPS will determine the language settings for the PCD that sent the audio message. This may be done either by looking up the language setting in the user profile associated with the PCD. Alternatively, the CPS can determine the spoken language using a language detection software and processes. The CPS will then convert the received audio message from speech to text in the spoken language.

The CPS then determines the other PCDs that comprise the HQ Security channel and the language settings (specifically the inbound communication language setting) in the user profile(s) for the other PCDs in the HQ Security channel. The CPS then translates (if necessary) the text of the converted original audio message into text in the language specified by the other PCDs in the HQ Security channel. This text is then converted to speech in the target language for each PCD.

In one embodiment, the CPS will re-broadcast the original audio message in the original language to all PCDs in the HQ Security channel. Simultaneously, the CPS will perform the translation process and relay the translated audio to each PCD in their specified language. If the receiving PCD has the same language settings as the sending PCD, no translation services are required for that receiving PCD.

In another embodiment, the CPS will not re-broadcast the original audio message in the original language to any PCDs having different language settings than the sending PCD. Rather, the CPS will perform the translation process and relay only the translated audio to each PCD in their specified language. If the receiving PCD has the same language settings as the sending PCD, no translation services are required for that receiving PCD.

When Bob is in transmit mode on the HQ Security channel and says “Is anyone on the 5^{th} floor?”, the audio message is relayed to the CPS. The CPS determines that the audio message is in English and also determines the language settings for the other three PCDs that comprise the HQ Security channel. In this example, the CPS translates the English audio message into English text. It then translates the English text to Spanish text and then converts the Spanish text to Spanish audio for Maria's PCD and translates the English text to Chinese text and then converts the Chinese text to Chinese audio for Alice's PCD. No translation is needed for Pierre's PCD as it has specified English as the preferred language for inbound communication.

Meanwhile the CPS may have processed the original audio message from Bob by broadcasting it in its original form to the other PCDs in the HQ Security channel. Thereafter, the CPS sends the translated Spanish audio to Maria's PCD and the translated Chinese audio to Alice's PCD.

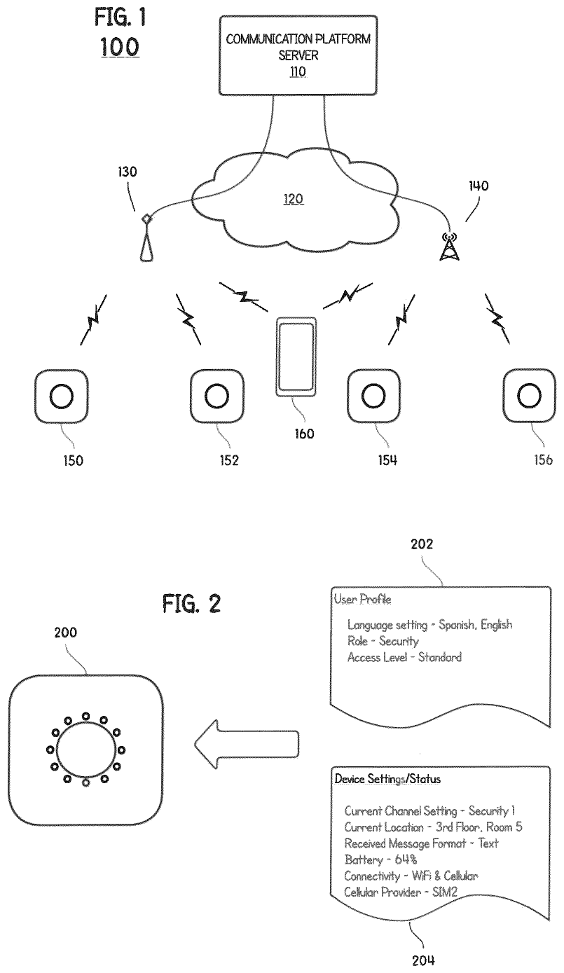

FIG. 1 illustrates a network environment for a wireless communication system according to the embodiments of the invention. A communications platform server (CPS) 110 is a cloud based remote server whose function is to manage communications among multiple portable communication devices (PCDs) 150, 152, 154, 156. While four (4) PCDs have been illustrated, the CPS may manage any number of PCDs.

The CPS 110 sits in a packet based computer network 120 such as, for instance, the Internet. The CPS may be configured to communicate directly with each PCD 150, 152, 154, 156 in the network. In this environment, the PCDs may be purpose built communication devices capable of multiple modes of wireless communication. A PCD may also be a smartphone device 160 that is also capable of multiple modes of wireless communication. The PCDs 150, 152, 154, 156 typically have two modes of connectivity that provide a connection with the CPS 110. A first may be WiFi (e.g., 802.11 type protocols and interfaces) that utilize a WiFi access point 130. A second may be cellular (e.g., cellular based RF wireless protocols and interfaces) that utilize a cellular basestation 140. The WiFi access point 130 and the cellular basestation 140 each have backhaul connectivity to the packet based computer network 120 for direct communication with CPS 110.

Anytime a PCD 150, 152, 154, 156 is within range of a WiFi access point 130 or a cellular basestation 140, it establishes a connection with the CPS and the CPS considers the PCD on-line.

FIG. 2 illustrates some of the data residing on a personal communication device (PCD) according to the embodiments of the invention. As mentioned above, a PCD 200 may store or have access to certain data necessary to enable the invention. For instance, PCD 200 may be loaded with a user profile 202 that may be comprised of, among other things, a language setting. The language setting is indicative of the language preference of a particular user when using PCD 200. Some users may be multi-lingual and may have multiple languages contained in their user profile. In such cases, the user may designate one of the languages as the preferred language. The preferred language will be the language in which incoming messages not matching any of the language settings in the user profile will be translated into.

PCD 200 may also store or have access to various device settings 204 or other status information. Some of the data stored may include a current logical channel setting and the current preferred received message format. The received message format may be changed by the user to reflect current preferences. For instance, when the user is in a location that is not suitable for spontaneous noisy message bursts, the current received message preference may be set to text. For participating in verbal conversations, the current received message preference may be set to voice.

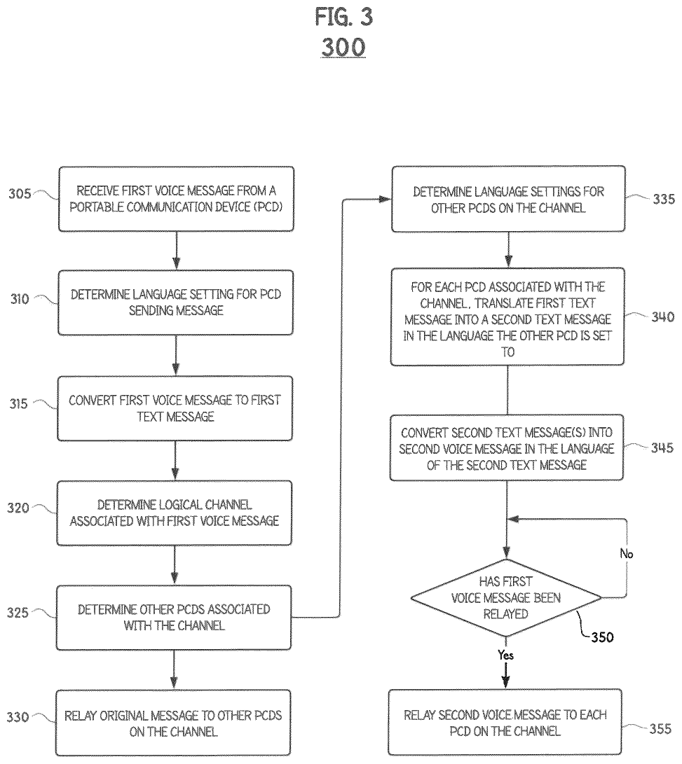

FIG. 3 is a logic flow diagram 300 describing a language translation process carried out by the communication platform server (CPS) 110. FIG. 3 may be described in the context of a four person user group (Bob, Maria, Pierre, and Alice) in which each user has their own user profile configured and executing on a PCD. The user profile may include language settings for outbound and inbound messages. In addition, it may be assumed that each PCD is on-line with the CPS and set to the same logical channel on which they are all members. Thus, when one member transmits a message on the channel, the other members will receive it. If the PCD for a member of the channel was not on-line or was not tuned to the proper channel, any inbound messages may not be received by that member's PCD or may be queued in a missed messages queue for later retrieval. Messages are generally in audio form similar to the way one would communicate using a walkie-talkie. For instance, a user engages transmit mode by depressing a button on a PCD and speaks into a microphone. Upon completion of the speech, the user releases the button to return to receive mode.

In step 305, the CPS 110 may receive an audio message from a PCD 150. For instance, Bob may engage transmit mode on his PCD 150 and speak the words, “Does anyone know where Jim is?” This audio message is transmitted wirelessly from Bob's PCD 150 via a Wifi 130 or cellular 140 connection through network 120 where it is received by CPS 110.

CPS 110 first determines the language of the received audio message in step 310. For instance, CPS 110 is aware of which PCD 150 sent the audio message. CPS 110 also knows which user profile 202 is currently associated with the PCD 150 that sent the audio message. In this example, Bob sent the audio message. The CPS 110 determines from Bob's user profile 202 that his language setting is set to English for both inbound and outbound communication. Alternatively, the CPS 110 may independently determine the language of the received message from Bob's PCD 150 by analyzing the audio itself.

Once the sending language has been determined, CPS 110 converts the audio into text in the same language in step 315. Here, the English audio is converted into English text. CPS 110 also knows which logical channel Bob's PCD 150 is currently set to in step 320 and uses that knowledge to look up other PCDs 152, 154, 156 that are included on that particular logical channel in step 325. Each logical channel may be given a label or name when it is created. This name is known to and stored by CPS 110, along with all other user profiles 202 that are members of that channel. For illustrative purposes, the logical channel in use may be named HQ Security channel. In this case, CPS 110 determines that Maria's PCD 152, Pierre's PCD 154, and Alice's PCD 156 are all included on the HQ Security channel.

CPS 110 may then fork into two paths. In the first path, CPS 110 will broadcast, in step 330, the original English audio message from Bob's PCD 150 to the other three PCDs 152, 154, 156 associated with Maria, Pierre, and Alice where it will be played back in English.

In the second path, CPS 110 will determine the language settings for each of the receiving PCDs 152, 154, 156 based on the user profile 202 for the PCDs 152, 154, 156 in step 335. CPS 110 determines that Maria's user profile 202 is set to Spanish for inbound communications, Pierre's user profile 202 is set to English for inbound communications, and Alice's user profile 202 is set to Chinese for inbound communications. CPS 110 may then translate the English text into Spanish text for Maria's PCD 152 and Chinese text for Alice's PCD 156 in step 340. No translation is needed for Pierre's PCD 154 because it is set to English which is the same language as the originally sent message. CPS 110 may then convert the Spanish translated text into Spanish speech for Maria's PCD 152 and the Chinese translated text into Chinese speech for Alice's PCD 156 in step 345.

At this point, CPS 110 may determine if it has broadcast, in step 330, the original English audio message from Bob's PCD 150 to the other three PCDs 152, 154, 156 in decision block 350. If not, CPS 110 will wait until step 330 occurs prior to relaying translated audio to any PCD 152, 154, 156 needing a translation in step 355. In this case, once the original audio has been broadcast in its original language, CPS 110 will send Maria's PCD 152 the translated Spanish audio and send Alice's PCD 156 the translated Chinese audio.

In this scenario, Maria will receive the original English audio followed immediately thereafter with a Spanish translation. Similarly, Alice will receive the original English audio followed immediately thereafter with a Chinese translation. Pierre may only receive the original English audio as his language setting specifies English and no translation is deemed necessary.

As stated earlier, the process may be implemented without first playing the original audio in the original language. For instance, Maria and Alice may only receive the translated audio in their respective languages without hearing the original message.

It should also be noted that since this is a speech-to-text followed by a text translation and finally a text-to-speech system, combinations of text and audio may be supported. For example, if the sending PCD 150 is text enabled, the original message may be sent as text which would negate the need for the first speech to text step. Similarly, any receiving PCDs 152, 154, 156 that are text enabled and have a preference of receiving text rather than audio would not need to have the text-to-speech step performed.

One can envision a scenario in which a member of the group may be in either a very noisy environment making audio difficult to hear or in a meeting where sudden audio emissions would be unwanted. In such cases, the PCDs 152, 154, 156 may be set to receive incoming messages via text.

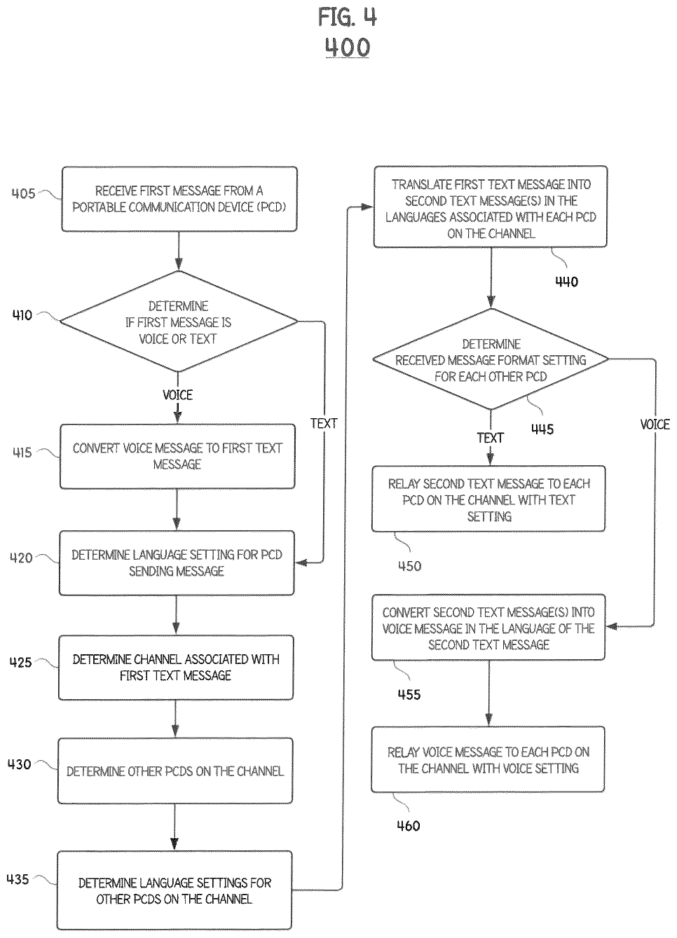

FIG. 4 is another logic flow diagram describing a language translation process carried out by a communication platform server. FIG. 4 may also be described in the context of a four person user group (Bob, Maria, Pierre, and Alice) in which each user has their own user profile configured and executing on a PCD. The user profile may include language settings for outbound and inbound messages. In addition, it may be assumed that each PCD is on-line with the CPS and set to the same logical channel on which they are all members. Thus, when one member transmits a message on the channel, the other members will receive it. If the PCD for a member of the channel was not on-line or was not tuned to the proper channel, any inbound messages may not be received by that member's PCD or may be queued in a missed messages queue for later retrieval. Messages may be in audio form similar to the way one would communicate using a walkie-talkie or text form similar to SMS or other text/data based direct messaging (DM) systems.

In step 405, the CPS 110 may receive a message from a PCD 150. For instance, Bob may engage transmit mode on his PCD 150 and speak the words, “Does anyone know where Jim is?” This audio message is transmitted wirelessly from Bob's PCD 150 via a Wifi 130 or cellular 140 connection through network 120 where it is received by CPS 110. Alternatively, Bob may send the message as a text message using a text based interface.

CPS 110 may first determine whether the received message is a voice message or a text message at decision block 410. The incoming data packets associated with the received message may be characterized as either voice or text. If the received message is determined to be voice, the voice message is converted to a first text message in step 415 using speech-to-text processing. If the received message is determined to be text, no further processing on the received message need be performed.

CPS 110 then determines the language setting of the PCD 150 that sent the message in step 420. For instance, CPS 110 is aware of which PCD 150 sent the message. CPS 110 also knows which user profile 202 is currently associated with the PCD 150 that sent the message. In this example, Bob sent the message. The CPS 110 determines from Bob's user profile 202 that his language setting is set to English for both inbound and outbound communication. Alternatively, the CPS 110 may independently determine the language of the received message from Bob's PCD 150 by analyzing the audio itself if the message was in voice format or the words if the message was in text format.

In our example, CPS 110 also knows which logical channel Bob's PCD 150 is currently set to in step 425 and uses that knowledge to look up other PCDs that are included on that particular logical channel in step 430. Each logical channel may be given a label or name when it is created. This name is known to and stored by CPS 110 along with all other user profiles that are members of that channel. For illustrative purposes, the logical channel in use may be named HQ Security channel. In this case, CPS 110 determines that Maria's PCD 152, Pierre's PCD 154, and Alice's PCD 156 are all included on the HQ Security channel.

CPS 110 may then determine the language settings for each of the receiving PCDs 152, 154, 156 based on the user profile 202 for the PCDs 152, 154, 156 in step 435. CPS 110 determines that Maria's user profile 202 is set to Spanish for inbound communications, Pierre's user profile 202 is set to English for inbound communications, and Alice's user profile 202 is set to Chinese for inbound communications. CPS 110 may then translate the English text into Spanish text for Maria's PCD 152 and Chinese text for Alice's PCD 156 in step 440. No translation is needed for Pierre's PCD 154 because it is set to English which is the same language as the originally sent message.

CPS 110 may then determine the received message format setting for each PCD 152, 154, 156 in decision block 445. For instance, any given PCD may be set to receive messages in voice format or text format. This is a setting controllable by the user. For PCDs set to receive messages as text, CPS 110 will send the second text message to that PCD in the language specified by the user's user profile 202 in step 450. In this example, Maria's PCD 152 may be set to receive text messages. The CPS 110 will forward the second text message which is now in Spanish to Maria's PCD 152.

For PCDs set to receive messages as voice, CPS 110 will convert the second text message intended for that PCD in the language specified by the user profile 202 in step 455. In this example, Pierre's PCD 154 and Alices's PCD 156 may be set to receive voice messages. The CPS 110 will then forward the voice message in English to Pierre's PCD 154 and in Chinese to Alice's PCD 156 in step 460.

In this scenario, Bob sent the original message from his PCD 150 as a text message on the HQ Security channel. Maria set her PCD 152 to receive messages in text format so she receives a Spanish translation text message of Bob's text message. Pierre set his PCD 154 to receive messages in voice format so he receives a text-to-speech English version of Bob's text message. Alice set her PCD 156 to receive messages in voice format so she receives a text-to-speech Chinese version of Bob's text message.

As stated earlier, the process may be implemented without first playing the original audio in the original language. For instance, Maria and Alice may only receive the translated audio in their respective languages without hearing the original message.

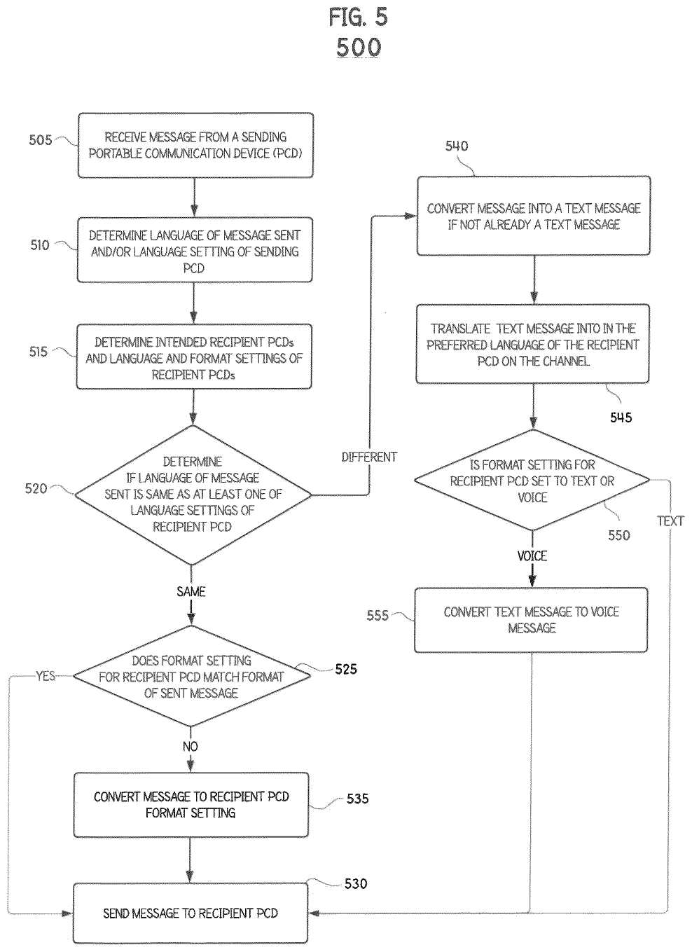

FIG. 5 is another logic flow diagram describing a language translation process according to embodiments of the invention. FIG. 5 may be described in the context of a one to one or one to many scenario in which a user sending a message may be sending it out to any number of recipients. Each user, sender and recipients, has their own user profile configured and executing on a PCD. The user profile may include language and format settings for outbound and inbound messages. In addition, it may be assumed that each PCD is on-line with the CPS and set to the same logical channel on which they are all members. Thus, when one member transmits a message on the channel, the other members will receive it. If the PCD for a member of the channel was not on-line or was not tuned to the proper channel, any inbound messages may not be received by that member's PCD or may be queued in a missed messages queue for later retrieval. Messages may be in audio form similar to the way one would communicate using a walkie-talkie or text form similar to SMS or other text/data based direct messaging (DM) systems.

In step 505, the CPS 110 may receive a message from a sending PCD 150. The sending PCD 150 may be associated with a particular user profile. The user profile may include language settings that specify one or more languages for which the user associated with the user profile can converse or read. In addition, the user profile may also include a format setting that is readily configurable or changeable by the user. The format setting may specify how incoming or received messages are to be played back. For instance, the format setting may be one of text or voice (e.g., audio). If the format setting is text, it is indicative that received messages be displayed in text form on a display of a PCD. If the format setting is voice, it is indicative that received messages be output in audio form via a speaker on a PCD. The user may opt for one format setting over another depending on their location. Louder than normal locations or locations where silence is preferred tend to prefer text output while other locations or situations tend to prefer voice output.

In step 510, the CPS 110 may determine the language of the message sent by the sending PCD 150. Determining the language of the message sent may be achieved by checking the language setting of the sending PCD 150. All active PCDs are registered on-line with the CPS 110 and the user profile associated with each on-line PCD is known to the CPS 110. The user profile may either be stored on the CPS 110 and/or accessible to the CPS 110 via its on-line connection to the sending PCD 150. Additionally, the message itself may include metadata that identifies the language of the message. Alternatively, the CPS 110 may process the content of the message itself using a language processor to detect the language of the message.

In step 515, the CPS 110 may determine the intended recipient PCD (e.g., 152) as well as the language and format settings associated with the intended recipient PCD 152. While the process is described for a single intended recipient PCD, the same process may be applied to each PCD when there are multiple intended recipient PCDs.

In step 520, the CPS 110 may determine, in a decision block, if the language of the message sent by the sending PCD 150 is the same as at least one of the language settings of the recipient PCD 152. For instance, the user of the recipient PCD 152 may by bi- or even multi-lingual and capable of conversing or reading several languages. Their user profile may list all of the languages that do not require translation services even if only one of the languages is a preferred language. The language settings may then be used to determine if a translation is necessary for bi- or multi-lingual users.

In step 525, when the language of the message sent by the sending PCD 150 is the same as at least one of the language settings of the recipient PCD 152 as determined in decision block 520, the CPS 110 may determine, in another decision block, whether the format setting for the recipient PCD 152 matches the format of the sent message. When the format setting for the recipient PCD 152 matches the format of the sent message, the CPS 110 will send the message to the recipient PCD 152 as is in step 530. When the format setting for the recipient PCD 152 does not match the format of the sent message, the CPS 110 will convert the sent message to the format setting indicated in the recipient PCD 152 in step 535 user profile before sending the message to the recipient PCD 152 in step 530. Such a conversion may be a speech-to-text (STT) process or a text-to-speech (TTS) process.

However, when the language of the message sent by the sending PCD 150 is not the same as at least one of the language settings of the recipient PCD 152 as determined in decision block 520, the CPS 110 may, in step 540, convert the sent message to a text message using a speech-to-text (STT) process if it is not already a text message. The CPS 110 may then perform a translation process in step 545 that translates the converted text message into the preferred language of the recipient PCD 152 based on the CPS's 110 knowledge of the recipient PCD's 152 user profile language settings.

In step 550, the CPS 110 may, in a decision block, determine if the format setting for the recipient PCD 152 is set to text. When the format setting for the recipient PCD 152 is set to text, the CPS may then send the message to the recipient PCD 152 via step 530. If the format setting for the recipient PCD 152 is set to voice, the CPS may convert the message to voice using a text-to-speech (TTS) process in step 555 and then send the message to the recipient PCD 152 via step 530.

The methods, devices, and systems described above are examples. Various configurations may omit, substitute, or add various procedures or components. For example, in alternative configurations, the methods may be performed in a different order. In another example, the methods may be performed with fewer steps, more steps, or in combination. In addition, certain configurations may be combined in various configurations. As technology evolves, many of the elements are examples and do not limit the scope of the disclosure or claims.

While some examples of methods, devices, and systems herein are described in terms of software executing on various machines, the methods and systems may also be implemented as specifically-configured hardware, such as a FPGA specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a RAM coupled to the processor. The processor executes computer-executable program instructions stored in memory, such as executing one or more computer programs. Such processors may comprise a microprocessor, a digital signal processor (“DSP”), an application-specific integrated circuit (“ASIC”), FPGAs, and state machines. Such processors may further comprise programmable electronic devices such as PLCs, programmable interrupt controllers (“PICs”), programmable logic devices (“PLDs”), programmable read-only memories (“PROMs”), electronically programmable read-only memories (“EPROMs” or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A method of translating a message intended for a recipient portable communication device (PCD) into a preferred language, the method comprising:
in a communications platform server (CPS):
receiving a sent message from a sending PCD intended for a recipient PCD over a first communication channel, the message being one of a voice message or a text message;
prior to sending the sent message to the recipient PCD over the first communication channel: (i) determining a language for the sent message received from the sending PCD; and (ii) determining two or more language settings associated with the recipient PCD;
when the language of the sent message matches at least one of the language settings associated with the recipient PCD, sending the sent message to the recipient PCD without performing a message translation process over the first communication channel; and
when the language of the message does not match any of the language settings associated with the recipient PCD, performing a message translation process to translate the sent message into a language setting associated with the recipient PCD and sending the translated sent message to the recipient PCD over the first communication channel.

2. The method of claim 1, wherein the sending PCD and recipient PCD are associated with a configurable user profile, the user profile including the language settings wherein one of the language settings is indicative of a preferred language setting of the recipient PCD.

3. The method of claim 2, wherein the CPS maintains a record of the user profiles associated with the sending PCD and recipient PCD.

4. The method of claim 3, wherein the configurable user profile includes a format setting for message playback, the format setting used to determine how messages received by the recipient PCD will be played.

5. The method of claim 4, wherein the format setting includes voice and text.

6. The method of claim 5, wherein when a translation process is not necessary:
determining the format setting for the recipient PCD;
when the format setting is set to text and the sent message from the sending PCD is a voice message, performing a speech-to-text conversion of the sent message; and
when the format setting is set to voice and the sent message from the sending PCD is a text message, performing a text-to-speech conversion of the sent message.

7. The method of claim 6, wherein the sent message is sent to the recipient PCD as a text message when the format setting is set to text and as a voice message when the format setting is set to voice.

8. The method of claim 5, wherein when a translation process is necessary:
converting the sent message from the sending PCD to a text message if the sent message from the sending PCD is a voice message; and
performing the translation process on the text message to translate it into the preferred language setting of the recipient PCD.

9. The method of claim 8, wherein:
when the format setting is set to text, the translated text message is sent to the recipient PCD; and
when the format setting is set to voice, the translated text message is converted to speech and sent to the recipient PCD.

10. A computing system for translating, in a communications platform server (CPS), a message intended for a recipient portable communication device (PCD) into a preferred language, comprising:
a non-transitory computer-readable medium; and
a processor in communication with the non-transitory computer-readable medium, the processor configured to execute instructions stored in the non-transitory computer-readable medium to:
receive a sent message from a sending PCD intended for a recipient PCD over a first communication channel, the message being one of a voice message or a text message;
prior to sending the sent message to the recipient PCD over the first communication channel: (i) determine a language for the sent message received from the sending PCD; and (ii) determine two or more language settings associated with the recipient PCD;
when the language of the sent message matches at least one of the language settings associated with the recipient PCD, send the sent message to the recipient PCD without performing a message translation process over the first communication channel; and
when the language of the message does not match any of the language settings associated with the recipient PCD, perform a message translation process to translate the sent message into a language setting associated with the recipient PCD and send the translated sent message to the recipient PCD over the first communication channel.

11. The computing system of claim 10, wherein the sending PCD and recipient PCD are associated with a configurable user profile, the user profile including the language settings wherein one of the language settings is indicative of a preferred language setting of the recipient PCD.

12. The computing system of claim 11, wherein the CPS maintains a record of the user profiles associated with the sending PCD and recipient PCD.

13. The computing system of claim 12, wherein the configurable user profile includes a format setting for message playback, the format setting used to determine how messages received by the recipient PCD will be played.

14. The computing system of claim 13, wherein the format setting includes voice and text.

15. The computing system of claim 14, wherein when a translation process is not necessary, the processor is configured to:
determine the format setting for the recipient PCD;
when the format setting is set to text and the sent message from the sending PCD is a voice message, perform a speech-to-text conversion of the sent message; and
when the format setting is set to voice and the sent message from the sending PCD is a text message, perform a text-to-speech conversion of the sent message.

16. The computing system of claim 15, wherein the processor is configured to send the sent message to the recipient PCD as a text message when the format setting is set to text and as a voice message when the format setting is set to voice.

17. The computing system of claim 14, wherein when a translation process is necessary the processor is configured to:
convert the sent message from the sending PCD to a text message if the sent message from the sending PCD is a voice message; and
perform the translation process on the text message to translate it into the preferred language setting of the recipient PCD.

18. The computing system of claim 17, wherein the processor is configured to:
when the format setting is set to text, send the translated text message to the recipient PCD; and
when the format setting is set to voice, convert the translated text message to speech and send it to the recipient PCD.

19. A non-transitory computer-readable medium comprising program instructions for translating a message intended for a recipient portable communication device (PCD) into a preferred language, the instructions executable by a processor within a communications platform server (CPS) to cause the processor to:
receive a sent message from a sending PCD intended for a recipient PCD over a first communication channel, the message being one of a voice message or a text message;
prior to sending the sent message to the recipient PCD over the first communication channel: (i) determine a language for the sent message received from the sending PCD; and (ii) determine two or more language settings associated with the recipient PCD;
when the language of the sent message matches at least one of the language settings associated with the recipient PCD, send the sent message to the recipient PCD without performing a message translation process over the first communication channel; and
when the language of the message does not match any of the language settings associated with the recipient PCD, perform a message translation process to translate the sent message into a language setting associated with the recipient PCD and send the translated sent message to the recipient PCD over the first communication channel.

20. The non-transitory computer-readable medium of claim 19, wherein the sending PCD and recipient PCD are associated with a configurable user profile, the user profile including the language settings wherein one of the language settings is indicative of a preferred language setting of the recipient PCD.

21. The non-transitory computer-readable medium of claim 20, wherein the CPS maintains a record of the user profiles associated with the sending PCD and recipient PCD.

22. The non-transitory computer-readable medium of claim 21, wherein the configurable user profile includes a format setting for message playback, the format setting used to determine how messages received by the recipient PCD will be played.

23. The non-transitory computer-readable medium of claim 22, wherein the format setting includes voice and text.

24. The non-transitory computer-readable medium of claim 23, wherein when a translation process is not necessary, the processor is configured to:
determine the format setting for the recipient PCD;
when the format setting is set to text and the sent message from the sending PCD is a voice message, perform a speech-to-text conversion of the sent message; and
when the format setting is set to voice and the sent message from the sending PCD is a text message, perform a text-to-speech conversion of the sent message.

25. The non-transitory computer-readable medium of claim 24, wherein the processor is configured to send the sent message to the recipient PCD as a text message when the format setting is set to text and as a voice message when the format setting is set to voice.

26. The non-transitory computer-readable medium of claim 23, wherein when a translation process is necessary the processor is configured to:
convert the sent message from the sending PCD to a text message if the received message from the sending PCD is a voice message; and
perform the translation process on the text message to translate it into the preferred language setting of the recipient PCD.

27. The non-transitory computer-readable medium of claim 26, wherein the processor is configured to:
when the format setting is set to text, send the translated text message to the recipient PCD; and
when the format setting is set to voice, convert the translated text message to speech and send it to the recipient PCD.
